(19) United States
(12) Patent Application Publication
(10) Pub. No.: US 2021/0232636 A1
(43) Pub. Date: Jul. 29, 2021

(54) METHOD AND SYSTEM FOR DEMAND-DRIVEN AUTOMOTIVE DATA EXTRACTION

(71) Applicant: Otonomo Technologies Ltd., Even Yehuda (IL)

(72) Inventor: Tomer Raanan, Ganey Tikva (IL)

(73) Assignee: Otonomo Technologies Ltd., Even Yehuda (IL)

(21) Appl. No.: 17/160,418

(22) Filed: Jan. 28, 2021

Related U.S. Application Data
(60) Provisional application No. 62/967,061, filed on Jan. 29, 2020.

(51) Int. Cl. G06F 16/903; G06F 16/9035

(52) U.S. Cl. CPC G06F 16/90335; G06F 21/6254; G06F 16/9035

(57) ABSTRACT

A method and a system for extracting automotive data on demand are provided herein. The method may include the following steps: analyzing automotive data requests issued by automotive data consumers, to determine demand for automotive data; extracting automotive data from the automotive data providers; and adjusting said extracting, based on the demand for the automotive data by said data consumers. The system may implement the aforementioned method over an electronic automotive data marketplace.

### CROSS-REFERENCE TO RELATED APPLICATIONS

This application claims the benefit of U.S. Provisional Patent Application No. 62/967,061, filed on Jan. 29, 2020, which is incorporated herein by reference in its entirety.

### FIELD OF THE INVENTION

The present invention relates generally to a computerized automotive marketplace and, more particularly, to extracting automotive data from data providers and managing same.

### BACKGROUND OF THE INVENTION

Prior to the background of the invention being set forth, it may be helpful to provide definitions of certain terms that will be used hereinafter.

The term “connected vehicle” or “connected car” as used herein is defined as a car or any other motor vehicle such as a drone or an aerial vehicle that is equipped with any form of wireless network connectivity enabling it to provide and collect data from the wireless network. The data originated from and related to connected vehicles and their parts is referred herein collectively as “automotive data”.

The term “data marketplace” or “data market” as used herein is defined as an online platform preferably implemented on a cloud that enables a plurality of users (e.g. subscribers or consumers) to access and consume data originated by various data sources (e.g. data providers). Data marketplaces typically offer various types of data for different markets and from different sources. Common types of data consumers include business intelligence, financial institutions, demographics, research and market data. Data types can be mixed and structured in a variety of ways. Data providers may offer data in specific formats for individual clients.

Data consumed in these marketplaces is used by businesses of all kinds, fleets, business and safety applications and many types of analysts. Data marketplaces have proliferated with the growth of big data, as the amount of data collected by municipalities and smart cities, businesses, websites and services has increased, and all that data has become increasingly recognized as an asset.

The term “data anonymization” as used herein is defined as type of information sanitization whose intent is privacy protection. It is the process of either encrypting or removing personally identifiable information from data sets, so that the people whom the data describe remain anonymous.

Connected vehicles are sending more and more data to the data providers cloud. Many of the cars can now send the data in ‘near real time’. The amount of data is getting bigger every day as more and more sensors are added to the cars. The car data can be used by many applications from different types—some of the data consumers require the data in real time for use cases like safety and emergency and road hazards, while other data consumers may settle for offline data for other use cases like machine learning (ML) training algorithms, User Base Insurance (UBI) and many more where data can be offline data.

The challenge that the automotive online marketplace faces is which data to send and in what way. It is clear that sending all the data in real time is advantageous as it can be valuable for may data consumers to receive the data with minimal latency. However, sending all data online all the time is a naïve approach that is not efficient, costs a lot and not scalable as the amount of data keeps scaling up.

On the other hand, sending data in a more offline way, for example in bulk of messages, is much more efficient and can be done in a much bigger scale, but this does not fit all the use cases, some of which require real time data.

### SUMMARY OF THE INVENTION

In order to address the challenge of processing an enormous amount of automotive data requests on electronic marketplaces, it has been suggested by the inventor of the present invention to provide an on-demand automotive data extractor operative within an automotive data marketplace that will enable a more efficient extraction of the automotive data from the data providers.

Some embodiments of the present invention provide a cloud-to-cloud smart extractor solution. This solution determines what need to be extracted and in what format to make sure all the required data is gathered and still avoid the very high cost of streaming everything all the time

As explained above, data providers in operative association with a data marketplace architecture usually have two main parts: a streaming pipeline, which collects all the automotive data from all the cars as they send it; and a data lake, which stores all the data for the long run and is an efficient way to save large amount of unstructured data.

Some embodiments of the present invention also have two similar parts that synchronize with an electronic automotive marketplace. A big challenge that is being addressed by some embodiments of the present invention is that, in order to extract the data online, it is desirable d to connect very early on the pipeline, where data is very much unprocessed (e.g. “raw data”). Therefore, in order to decide what to extract, it is required need to have a dictionary of the relevant parameters in accordance with the metadata describing what every sensor means, its unit at the data providers.

According to some embodiments of the present invention, a method and a system for extracting automotive data on demand are provided herein. The method may include the following steps: analyzing automotive data requests issued by automotive data consumers, to determine demand for automotive data; extracting automotive data from the automotive data providers; and adjusting said extracting, based on the demand for the automotive data by said data consumers. The system may implement the aforementioned method over an electronic automotive data marketplace.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustrating non-limiting exemplary architecture of one system in accordance with some embodiments of the present invention; and

FIG. 2 is a high-level flowchart illustrating non-limiting exemplary method in accordance with embodiments of the present invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

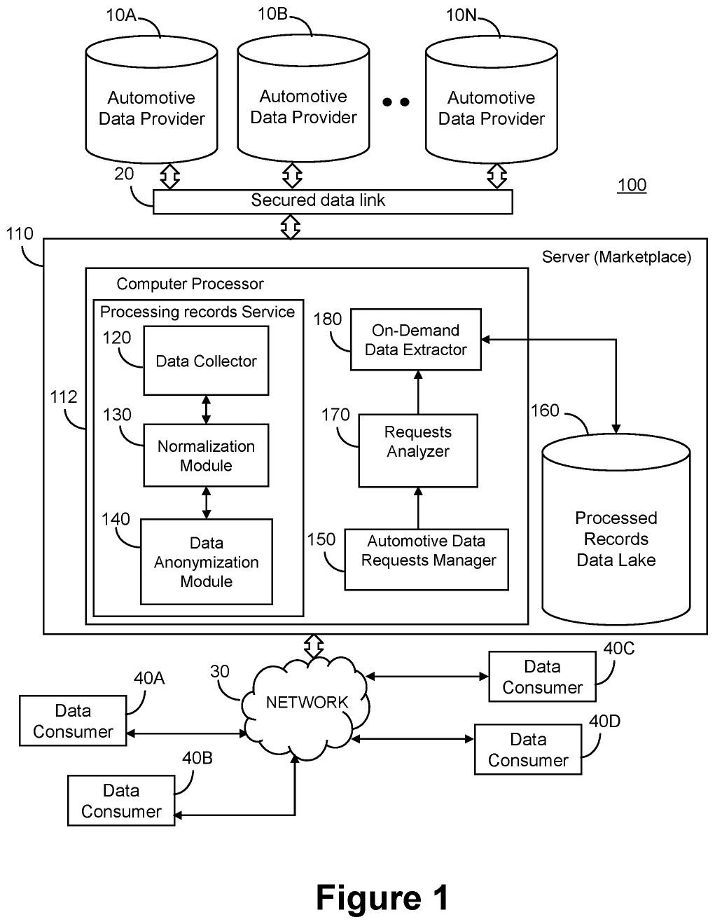

FIG. 1 is a block diagram illustrating non-limiting exemplary architecture of the system in accordance with some embodiments of the present invention. Automotive data distribution network 100 may include at least one automotive data distribution server 110 which may, in preferable embodiments, be a secured automotive data server fully compliant with data protection and privacy regulations.

Server 110 may be implementing a data marketplace and connected via network 30 to a plurality of data consumers 40A-40D. Vehicle related data, possibly obtained from various sensors may be stored in raw format on a plurality of vehicle related data sources such as automotive data providers 10A-10N and are accessed by server 110 via a secured data link 20. Server 110 may include a processing records service implemented by a computer readable code running on computer processor 112. Processing records service may include a data collector 120, a normalization module 130 and a data anonymization module 140 that are configured to collect, normalize and anonymize respectively the data arriving from the plurality of vehicle related data sources 10A-10N, thus creating a processed records data lake 160 storing vehicle related data. The processed automotive data records are being consumed and used by various data services modules implemented by a computer code running on computer processor 120 on server 110 responsive to various requests from plurality of data consumers 40A-40D in a manner that does not compromise the privacy of the data owners (e.g. drivers).

According to some embodiments of the present invention, server 110 may further include an automotive data requests manager 150 implemented on a computer processor 112 which receives requests for automotive data by data consumers 40A-40D. Server 110 may further include a request analyzer 170 implemented on computer processor 112 which analyzes the requests, to determine demand for automotive data. Server 110 may further include an on-demand data extractor 180 implemented on computer processor 112 which extracts automotive data from the automotive data providers 10A-10N and adjusts the extracting, based on the demand for the automotive data by data consumers 40A-40D.

According to some embodiments of the present invention, the demand may include at least one of: type of automotive data, format of automotive data, and quality of automotive data.

According to some embodiments of the present invention, the adjusting may include prioritizing a first characteristic of automotive data over a second characteristic of automotive date.

According to some embodiments of the present invention, the prioritizing may include early processing and delivery of demanded automotive data associated with a predefined characteristic.

According to some embodiments of the present invention, the first characteristic of automotive data may include automotive data that is required for processing in real-time, wherein the second characteristic of automotive data comprises automotive data that is required for offline/batch processing.

According to some embodiments of the present invention, the first characteristic of automotive data may include automotive data provided in high quality, wherein the second characteristic of automotive data comprises automotive data that is required in low quality.

According to some embodiments of the present invention, the extracting may be carried out locally at said data providers.

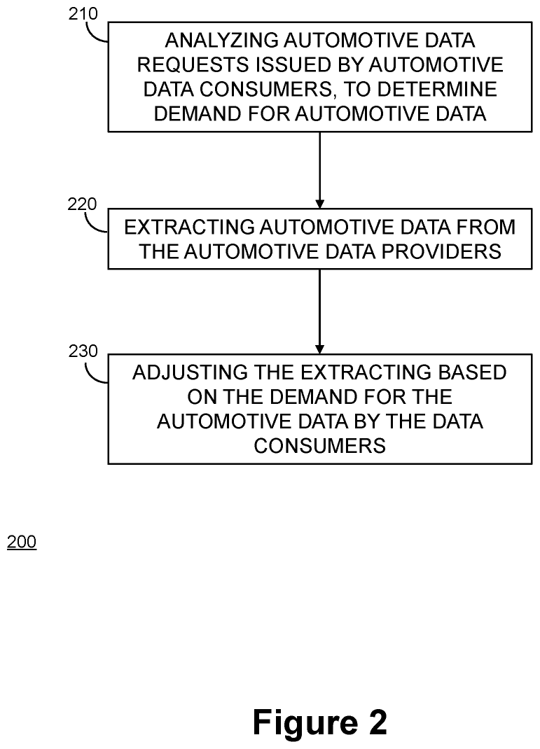

FIG. 2 is a high-level flowchart illustrating non-limiting exemplary method in accordance with embodiments of the present invention. A method 200 of extracting automotive data on demand is illustrated herein. Method 200 may include the following steps: analyzing automotive data requests issued by automotive data consumers, to determine demand for automotive data 210; extracting automotive data from the automotive data providers 220; and adjusting the extracting, based on the demand for the automotive data by the data consumers 230.

According to some embodiments of the present invention, the demand includes at least one of: type of automotive data, format of automotive data, and quality of automotive data.

According to some embodiments of the present invention, the adjusting may include prioritizing a first characteristic of automotive data over a second characteristic of automotive date.

According to some embodiments of the present invention, the prioritizing may include early processing and delivery of demanded automotive data associated with a predefined characteristic.

According to some embodiments of the present invention, the first characteristic of automotive data may include automotive data that is required for processing in real-time, and the second characteristic of automotive data may include automotive data that is required for processing off-line.

According to some embodiments of the present invention, the first characteristic of automotive data may include automotive data provided in high quality, and the second characteristic of automotive data may include automotive data that is required in low quality.

According to some embodiments of the present invention, the following description provides a potential implementation of the invention for set-up, consuming historical data, adding a data consumer for online data consumption and adding another data consumer with a different data set. It is clear that the following is a mere example showing how knowledge about demand and supply of online/offline data can be leveraged to increase the efficiency of the computer hardware resources (e.g. computer processors, memory, databases) of an automotive marketplace online platform.

In an initial setup stage, the online extractor is connected to the data provider queue, while an offline extractor is connected to the data lake. Then, a normalization policy is prepared to map the data providers (e.g. car manufacturer, or OEM) names convention parameters that may be needed to be extracted online. Subsequently, the full list of parameters mapping is maintained at the cloud in the main normalization service.

The flow for historical data is as follows: before any applications (data consumers) are connected, online extractor is not doing anything, unstructured anonymized data is sent from the offline extractor to the normalization engine and from there to the data lake in the most efficient offline format. This data is saved in the data lake even if no app needs it yet for future re-use. Then data is sent in an unstructured way in the data provider conventions to the normalization engine where the data is normalized on the cloud in a bulk efficient way possibly off-line, as no real time normalization is needed. As soon as a data consumer is registered on the marketplace to get historical data, since all the relevant data was already collected to the data lake, it is simple to provide the data consumer with the data it requires.

Following is a flow for online data, adding a data consumer (e.g., App2): as soon as another data consumer is registered to the marketplace and requests data set 1, data set 1 is mapped to normalization policy and sent to the normalization server that sits on the provider side. Then, the normalization extractor reads the policy from normalization, extracts the data set, normalizes only the relevant parameters and sends it to the streaming mechanism from which Apps2 consumes the data online.

Following is a flow for online data, adding a data consumer (e.g., App3): App3 is added with new data set 2. The new data set is sent again to the data provider extractor. The normalization policy is now a unity of data set 1 and data set 2, so there is no need to send the same parameter twice. All the united data from App1 and App2 together is extracted in real time and sent to the streaming service. The streaming service divides the union data (data set 1 and dataset 2) between App2 and App3 according to the required data sent.

In order to implement method 200 according to some embodiments of the present invention, a computer processor may receive instructions and data from a read-only memory or a random-access memory or both. At least one of aforementioned steps may be performed by at least one processor associated with a computer. The essential elements of a computer are a processor for executing instructions and one or more memories for storing instructions and data. Generally, a computer will also include, or be operatively coupled to communicate with, one or more mass storage devices for storing data files. Storage modules suitable for tangibly embodying computer program instructions and data include all forms of non-volatile memory, including, by way of example, semiconductor memory devices, such as EPROM, EEPROM, and flash memory devices and magneto-optic storage devices.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in base band or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++, Python or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Some aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram portion or portions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram portion or portions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram portion or portions.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which may include one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment”, “an embodiment”, or “some embodiments”, do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional elements.

It is to be understood that where the claims or specification refer to “a” or “an” element, such reference is not be construed that there is only one of that elements.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method of extracting automotive data on demand, the method comprising:
analyzing automotive data requests issued by automotive data consumers, to determine demand for automotive data;
extracting automotive data from the automotive data providers; and
adjusting said extracting, based on the demand for the automotive data by said data consumers,
wherein the analyzing, the extracting, and the adjusting are carried out by one or more computer processors.

2. The method according to claim 1, wherein the demand includes at least one of: type of automotive data, format of automotive data, and quality of automotive data.

3. The method according to claim 1, wherein the adjusting comprises prioritizing a first characteristic of automotive data over a second characteristic of automotive data

4. The method according to claim 3, wherein the prioritizing comprises early processing and delivery of demanded automotive data associated with a predefined characteristic.

5. The method according to claim 3, wherein the first characteristic of automotive data comprises automotive data that is required for processing in real-time and wherein the second characteristic of automotive data comprises automotive data that is required for offline/batch processing.

6. The method according to claim 3, wherein the first characteristic of automotive data comprises automotive data provided in high quality and wherein the second characteristic of automotive data comprises automotive data that is required in low quality.

7. The method according to claim 1, wherein the extracting is carried out locally at said data providers.

8. A system for extracting automotive data on demand, the system comprising:
an automotive data request manager implemented on a computer processor which receives requests for automotive data by data consumers;
a request analyzer implemented on said computer processor which analyzes said requests, to determine demand for automotive data; and
an on-demand data extractor implemented on said computer processor which extracts automotive data from the automotive data providers and adjusts said extracting, based on the demand for the automotive data by said data consumers.

9. The system according to claim 8, wherein the demand includes at least one of: type of automotive data, format of automotive data, and quality of automotive data.

10. The system according to claim 8, wherein the adjusting comprises prioritizing a first characteristic of automotive data over a second characteristic of automotive data.

11. The system according to claim 10, wherein the prioritizing comprises early processing and delivery of prioritized automotive data associated with a predefined characteristic.

12. The system according to claim 10, wherein the first characteristic of automotive data comprises automotive data that is required for processing in real-time, and wherein the second characteristic of automotive data comprises automotive data that is required for offline/batch processing.

13. The system according to claim 10, wherein the first characteristic of automotive data comprises automotive data provided in high quality, and wherein the second characteristic of automotive data comprises automotive data that is required in low quality.

14. The system according to claim 8, wherein the extracting is carried out locally at said data providers.

15. A non-transitory computer readable medium for extracting automotive data on demand, the computer readable medium comprising a set of instructions that, when executed, cause at least one computer processor to:
receive requests for automotive data by data consumers;
analyze said requests, to determine demand for automotive data;
extract automotive data from the automotive data providers; and
adjust said extracting, based on the demand for the automotive data by said data consumers.

16. The non-transitory computer readable medium according to claim 15, wherein the demand includes at least one of: type of automotive data, format of automotive data, and quality of automotive data.

17. The non-transitory computer readable medium according to claim 15, wherein the adjusting comprises prioritizing a first characteristic of automotive data over a second characteristic of automotive data.

18. The non-transitory computer readable medium according to claim 17, wherein the prioritizing comprises early processing and delivery of demanded automotive data associated with a predefined characteristic.

19. The non-transitory computer readable medium according to claim 17, wherein the first characteristic of automotive data comprises automotive data that is required for processing in real-time, and wherein the second characteristic of automotive data comprises automotive data that is required for offline/batch processing.

20. The non-transitory computer readable medium according to claim 17, wherein the first characteristic of automotive data comprises automotive data provided in high quality, and wherein the second characteristic of automotive data comprises automotive data that is required in low quality.
